(19) United States
(12) Patent Application Publication
(10) Pub. No.: US 2005/0030234 A1
(43) Pub. Date: Feb. 10, 2005

(54) Air vent

(75) Inventor: Dirk Lauhoff, Kaiserslautern (DE)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW Automotive Electronics & Components GmbH & Co. KG

(21) Appl. No.: 10/686,980

(22) Filed: Oct. 16, 2003

(30) Foreign Application Priority Data
Oct. 16, 2002 (DE) 202 15 898.5

(51) Int. Cl. H01Q 1/32

(52) U.S. Cl. 343/713

(57) ABSTRACT

An air vent to be mounted on a vehicle body, has a frame molded of a plastic material and an antenna with a metallic antenna body. The antenna body is incorporated in the frame by being embedded in the plastic material or by over-molding the frame and antenna body with plastic material.

The present invention relates to an air vent to be mounted on a vehicle body, having a frame made of plastic and at least one electric or electronic component that is attached to the frame.

In air vents in the automotive sector, an antenna or a sensor may be mounted outside the vehicle onto the frame of the air vent to avoid radiation shielding by the car body. A connection cable for the antenna or sensor is passed through an opening in the frame and the opening is sealed. Subsequently, a connection plug is attached to the cable.

Conventionally, such an antenna (that may e.g. be used for emergency calls) is attached to the frame of the air vent by frame-integrated holding means (clips or tabs) or by separate clips. An assembly consisting of the air vent and the antenna with connection cable and plug is then mounted onto the vehicle.

This known technology entails high costs because of complex tooling for fastening and tolerance compensation with aligning elements such as, for example, spring shackles, hooks, undercuts, contact ribs or support ribs. Special tools are required for other fastening elements such as, for example, screws, rivets, clips, etc. The assembly costs are increased by the requirement of a tolerance compensation for the separate parts. Finally the electronic or electric component is exposed to environmental influence and, in particular, to humidity.

According to the present invention, the air vent has a frame molded of a plastic material and the at least one electric or electronic component is embedded and over-molded in the plastic material. By simply embedding in and over-molding the component with the frame, a number of advantages is achieved over the prior art. Among these are the following;
assembly costs are reduced
tolerance problems are avoided
the sealing on the vehicle body is improved
the component is safely attached to the frame of the air vent
the number of parts is reduced
there is a quality improvement through reduction of the production steps or sources of error
fewer tools can be used
the component is sealed in the plastic material and thus well protected from deterioration by environmental influence.

When the component is an antenna, the antenna body is embedded in the frame of the air vent by means of injection molding. As an alternative, a frame core is provided that has a recess for accommodation of the antenna. The frame core with the antenna body are then taken to a mold and over-molded with plastic material, thereby incorporating the antenna in the frame of the air vent. Other components such as an antenna micro-strip, circuit parts and connectors may incorporated in the frame of the air vent simultaneously and in a similar manner.

A preferred embodiment of the invention will now be described with reference to the attached drawing wherein

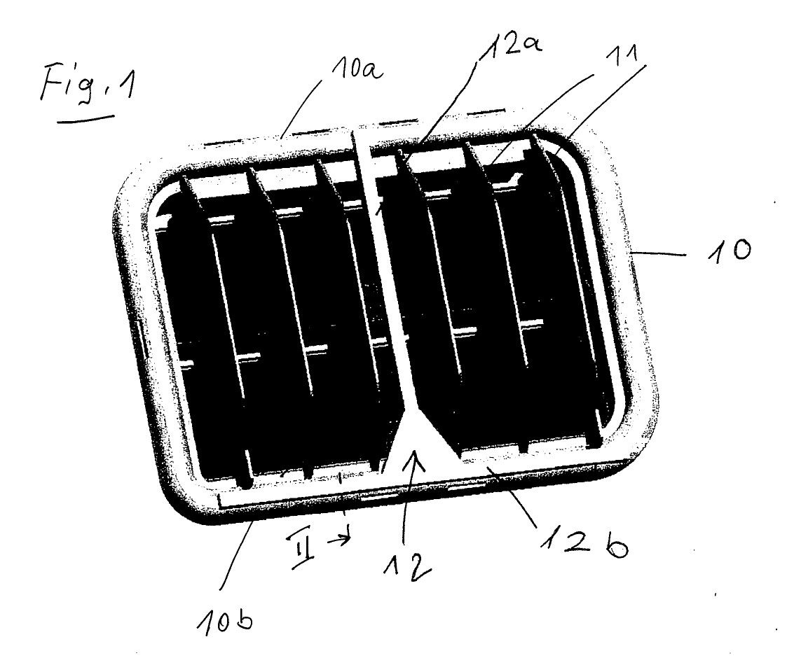

FIG. 1 is a perspective view of an air vent to be mounted on a vehicle body;

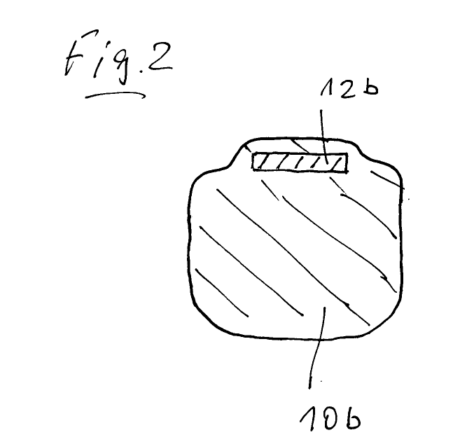

FIG. 2 is a cross-section along line II-II in FIG. 1; and

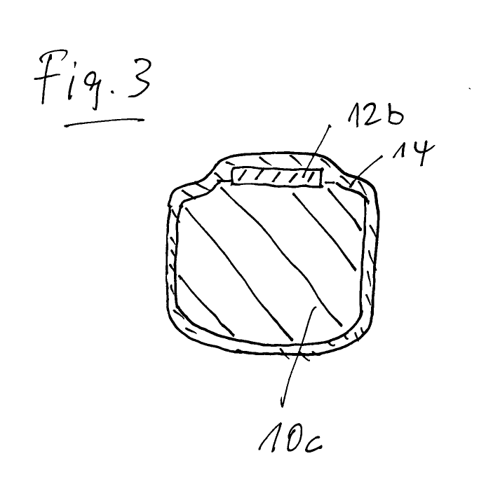

FIG. 3 a similar cross-section of an alternative embodiment.

The air vent has a generally rectangular frame 10 with two pairs of opposed frame sections. The longer ones 10a, 10b of opposed frame sections are spanned by a plurality of ribs 11. The frame with the ribs 11 is injection-molded from a plastic material. An antenna is incorporated in the frame. Specifically, the antenna has a generally T-shaped metallic body 12 with a first branch 12a that spans the frame sections 10a, 10b centrally of the frame and a second branch 12b perpendicular to the first branch 12a and extending along frame section 12b.

In FIG. 1, the antenna body appears as raised above the outer surface of the vent frame and covered with plastic material. As seen in FIG. 2, the antenna body is in fact embedded in the body of the vent frame. This is achieved by placing the antenna body in a cavity of an injection mold and injecting the plastic material around the antenna body.

In the alternative embodiment of FIG. 3, a frame core 10c has a locating recess for accommodation of the antenna body, the frame core 10c with the antenna body are taken to a mold cavity and both are over-molded with plastic material, forming an outer layer 14 of the frame, whereby the antenna is incorporated in the frame of the air vent.

1. An air vent to be mounted on a vehicle body, having a frame molded of a plastic material and at least one electric or electronic component that is embedded in the plastic material.

2. An air vent to be mounted on a vehicle body, having a frame with a frame core molded of a plastic material and at least one electric or electronic component that is accommodated in a locating recess of the frame core, the frame core with the component being over-molded with plastic material.

3. The air vent according to claim 1 or claim 2, wherein the component is integrated into the frame by injection-molding.

4. The air vent according to one of the preceding claims, wherein the component is one of the following:
an antenna
an antenna microstrip
a connection plug
a sensor.

5. The air vent of claim 4, wherein the frame is generally rectangular with a plurality of ribs spanning two opposed frame sections, and the component is an antenna that consists of a T-shaped metallic body with a first branch spanning the opposes frame sections and a second branch extending along one of the opposed frame sections.
